(19) United States
(12) Patent Application Publication
(10) Pub. No.: US 2012/0172768 A1
(43) Pub. Date: Jul. 5, 2012

(54) MASSAGE MACHINE

(75) Inventors: Munekiyo Ikebe, Shiga (JP); Takashi Yukawa, Osaka (JP); Masaki Nagano, Osaka (JP)

(73) Assignee: PANASONIC CORPORATION, Osaka (JP)

(21) Appl. No.: 13/393,421

(22) PCT Filed: Sep. 3, 2010
(86) PCT No.: PCT/JP2010/065117

§ 371 Date: Feb. 29, 2012

(30) Foreign Application Priority Data
Sep. 18, 2009 (JP) 2009-217735

(51) Int. Cl. A61H 1/00

(52) U.S. Cl. 601/19

(57) ABSTRACT

A massage machine includes a seat and a backrest, and a massage mechanism including a massaging element is provided within the backrest. The massaging element is provided on an arm of the massage mechanism and includes a first heat transfer unit in which a heat source is contained, a second heat transfer unit which is connected to the first heat transfer unit, and a rubbing roller which is supported by at least one of the first heat transfer unit and the second heat transfer unit. The configuration enables the first heat transfer unit to transfer to the user the heat transferred from the heat source and also enables the second heat transfer unit to transfer to the user the heat transferred from the first heat transfer unit.

### TECHNICAL FIELD

The present invention relates to a massage machine including a backrest that incorporates a massage mechanism.

### BACKGROUND ART

Massage machines include a backrest that incorporates a massage mechanism, which presses a rubbing roller of the massage mechanism against a trigger point or meridian and produces a predetermined motion to enhance blood circulation and resolve shoulder or back stiffness. Such massage machines have become widely used in average households and public facilities.

To perform massages close to what would be given by a person, recent massage machines include a heat source in the massage mechanism. This adds human warmth to the massaging with the massaging motion of the rubbing roller (refer to, for example, patent publication 1).

In the massage machine of patent publication 1, the rubbing roller, which is pressed against the user's body, includes two semispherical elastic members holding in between a heat transferring means (disk), which accommodates a heat source. Heat is transferred from the heat source through the heat transferring means to the user's body.

### PRIOR ART DOCUMENTS

Patent Publication 1: Japanese Laid-Open Patent Publication No. 2008-284338

### SUMMARY OF THE INVENTION

### Problems that are to be Solved by the Invention

In the above massage machine, the heat generated by the heat source is transferred to the user only by the heat transferring means that holds the two elastic members. Thus, the heat is applied to a narrow area. Accordingly, it is difficult to transfer the heat to a wide area from the heat source in a preferred manner.

It is an object of the present invention to provide a massage machine that transfers heat from a heat source in a further preferred manner.

### Means for Solving the Problems

One aspect of the present invention is a massage machine. The massage machine includes a seat and a backrest. A massage mechanism is arranged in the backrest. A massaging element is arranged in the massage mechanism. The massaging element includes an arm connected to the massage mechanism, a first heat transfer unit connected to the arm. The first heat transfer unit accommodates a heat source and is capable of transferring heat from the heat source to a user. A second heat transfer unit is connected to the first heat transfer unit. The second heat transfer unit is capable of transferring heat from the first heat transfer unit to the user. A rubbing roller is supported by at least one of the first and second heat transfer units.

In this structure, in addition to the first heat transfer unit, which accommodates the heat source, the second heat transfer unit applies heat to the user. Thus, heat can be transferred from the heat source in a further preferred manner.

### BRIEF DESCRIPTION OF THE DRAWINGS

FIG. 1 is a schematic diagram showing one embodiment of a massage machine.

FIG. 2 is a front view showing a massaging element arranged in the massage machine of FIG. 1.

FIG. 3 is an exploded perspective view showing the massaging element of FIG. 2.

FIG. 4 is a partial cross-sectional view showing the massaging element of FIG. 2.

FIG. 5 is a schematic block diagram of a temperature control mechanism arranged in the massage machine of FIG. 1.

FIG. 6 is a schematic graph illustrating the temperature control executed by the temperature control mechanism of FIG. 5.

FIGS. 7(a) and 7(b) are schematic diagrams showing a massaging motion produced near the neck by the massage machine of FIG. 1.

FIGS. 8(a) and 8(b) are schematic diagrams showing a massaging motion produced near the back by the massage machine of FIG. 1.

### EMBODIMENTS OF THE INVENTION

One embodiment of a massage machine 10 will now be described with reference to the drawings.

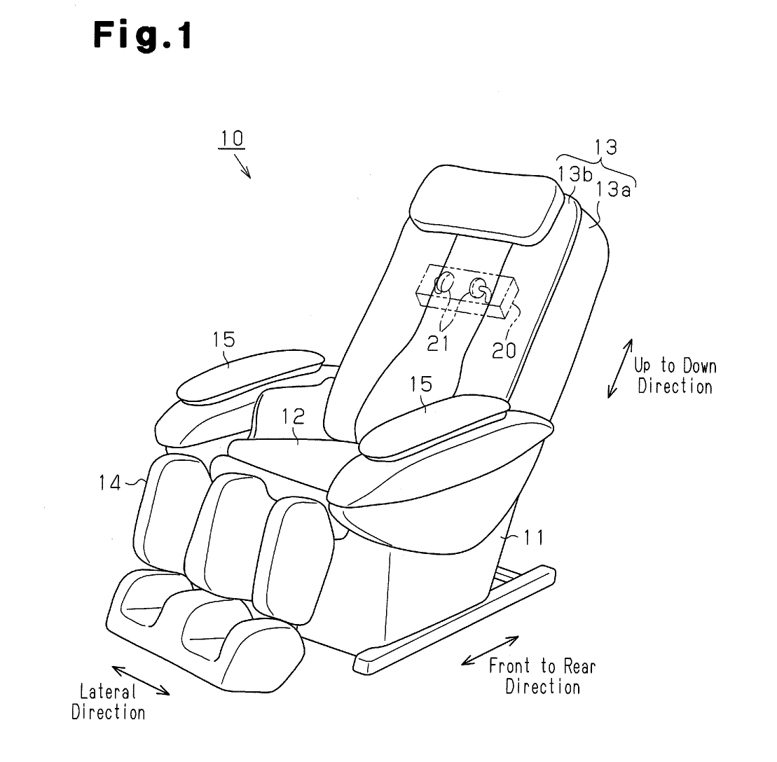

FIG. 1 schematically shows the structure of the massage machine 10. As shown in FIG. 1, the massage machine 10 includes a leg 11 arranged on a floor surface, which is not shown in the drawing. A seat 12, onto which a user can be seated, is fixed to an upper part of the leg 11. A reclinable backrest 13 is arranged at a rear part of the seat 12 to rest the user's back. A reclinable ottoman 14 is arranged at a front part of the seat 12 to rest the user's feet. Further, armrests 15 are arranged at opposite sides of the seat 12 extending from the backrest 13 to the front of the seat 12 to rest the user's arms.

The backrest 13 includes a backrest body 13a and a cover 13b, which covers a front surface of the backrest body 13a. The backrest body 13a includes a massage mechanism 20, which is arranged in a body case (not shown) having an open front and formed from a hard resin material. Guide rails (not shown) are arranged in the body case along the vertical direction of the backrest 13. The massage mechanism 20 is coupled to the guide rails in a vertically movable manner. The massage mechanism 20 includes various types of drive motors, which are not shown in the drawings, to vertically move the massage mechanism 20. The massage mechanism 20 includes two massaging elements 21, which are driven by a drive motor, and produces a predetermined massaging motion with the two massaging elements 21.

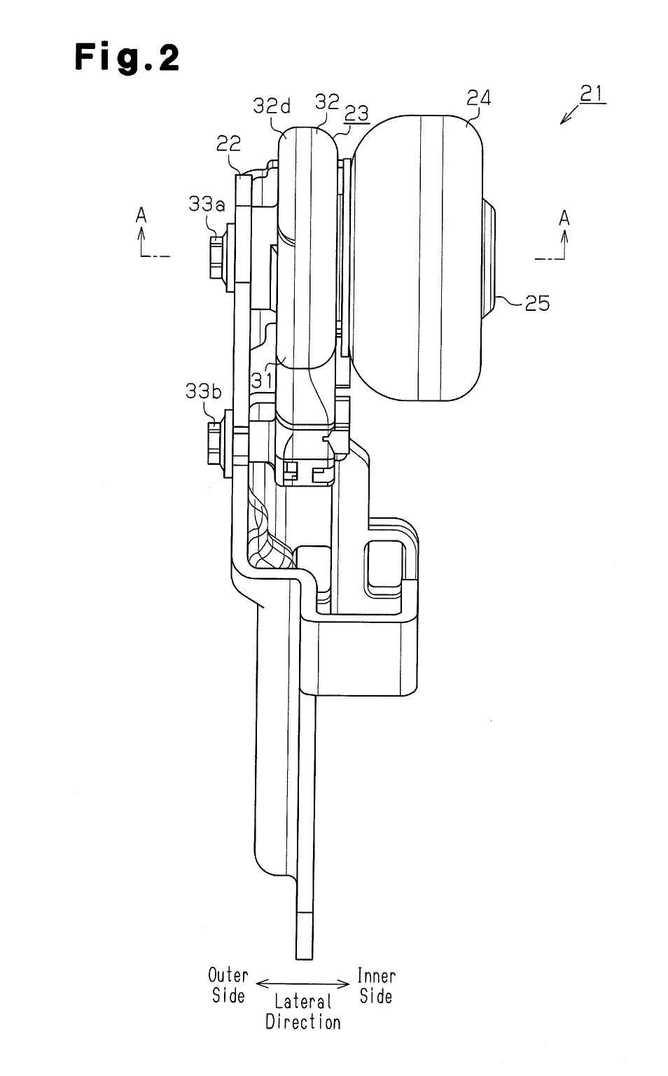

The structure of the massaging elements 21 will now be described. The two massaging elements 21 have the same structure. Thus, the structure of only one of the massaging elements 21 will be described. As shown in FIG. 2, the massaging element 21 includes an arm 22, which is connected to the massage mechanism 20, a heater unit 23, which is arranged on the arm 22 and serves as a first heat transfer unit, a connection member 25, which is connected to the heater unit 23 and serves as a second heat transfer unit, and a rubbing roller 24, which is arranged between the heater unit 23 and the connection member 25. As will be described later, in the present embodiment, the rubbing roller 24 is held between the heater unit 23 and the connection member 25.

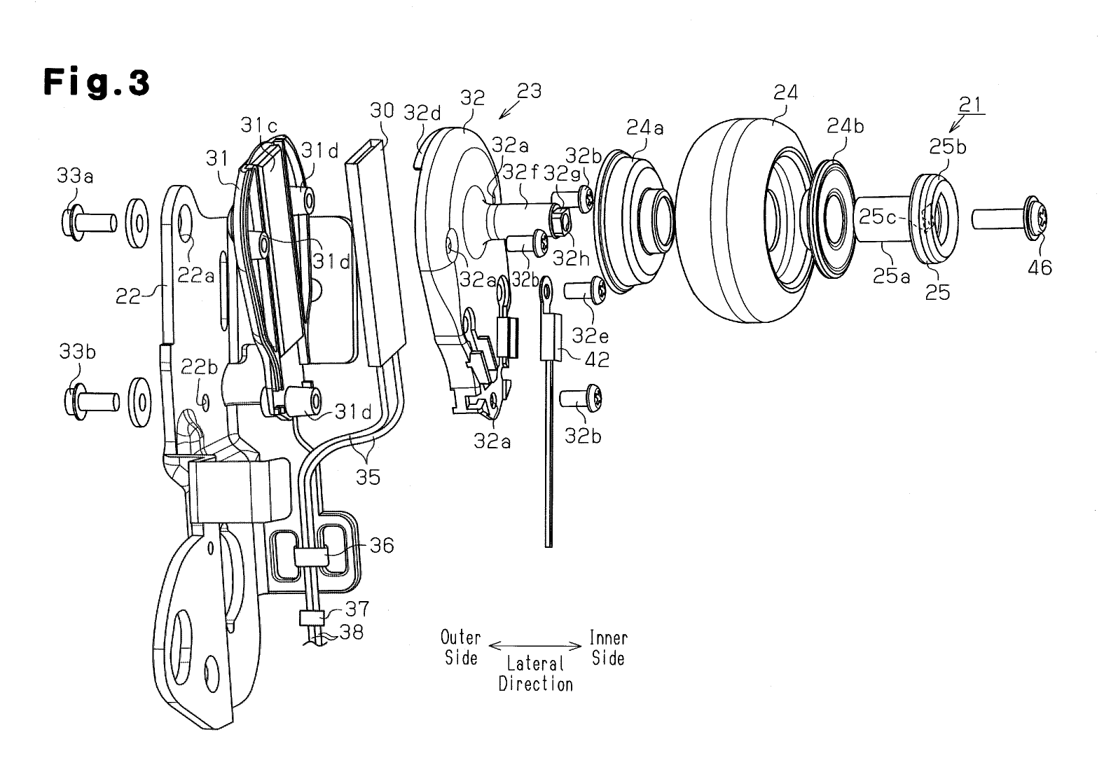

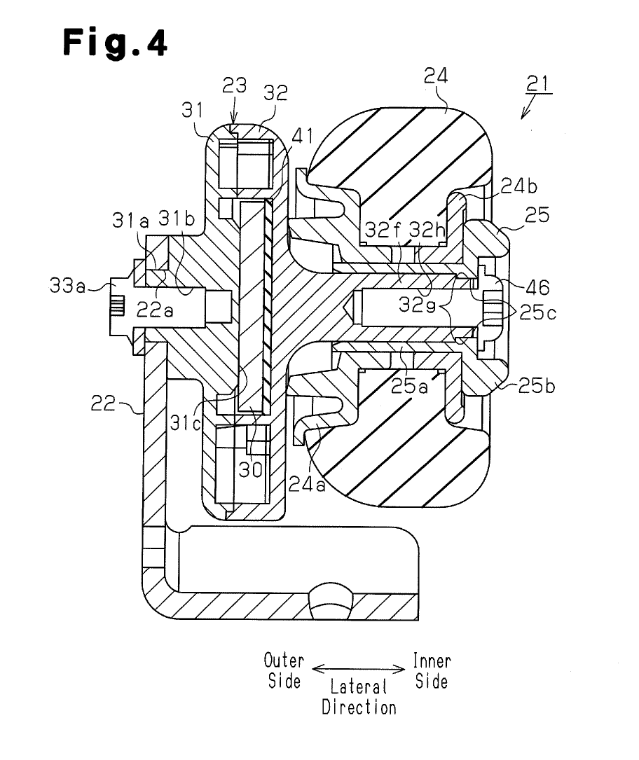

As shown in FIGS. 3 and 4, the heater unit 23 includes a positive temperature coefficient (PTC) heater 30, which serves as a heat source, and a first case member 31 and second case member 32, which hold the PTC heater 30 in between. In a lateral direction, which is the direction between the two massaging elements 21, the heater unit 23 is arranged at an inner side of the arm 22. The case members 31 and 32 use aluminum as a material having high thermal conductivity and rigidity.

The first case member 31 is arranged outward in the lateral direction from the second case member 32 and fixed by screws 33a and 33b to the arm 22. The first case member 31 includes an outer surface at the outer side in the lateral direction. A projection 31a (refer to FIG. 4) projecting outward in the lateral direction is formed on the outer surface. The projection 31a, which includes a first threaded hole 31b, is inserted into a large diameter through hole 22a, which extends through the arm 22 in the lateral direction. A second threaded hole (not shown) is formed in the outer surface of the first case member 31 at a position aligned with a small diameter through hole 22b, which extends through the arm 22 in the lateral direction. Screws 33a and 33b are respectively fastened to the first threaded hole 31b and second threaded hole to fix the first case member 31 to the arm 22.

The first case member 31 includes an inner surface at the inner side in the lateral direction. As shown in FIGS. 3 and 4, an abutment portion 31c, which abuts the PTC heater 30, is formed on the inner surface of the first case member 31 projecting inward in the lateral direction. Further, the inner surface of the first case member 31 includes three projections 31d, which project inward in the lateral direction.

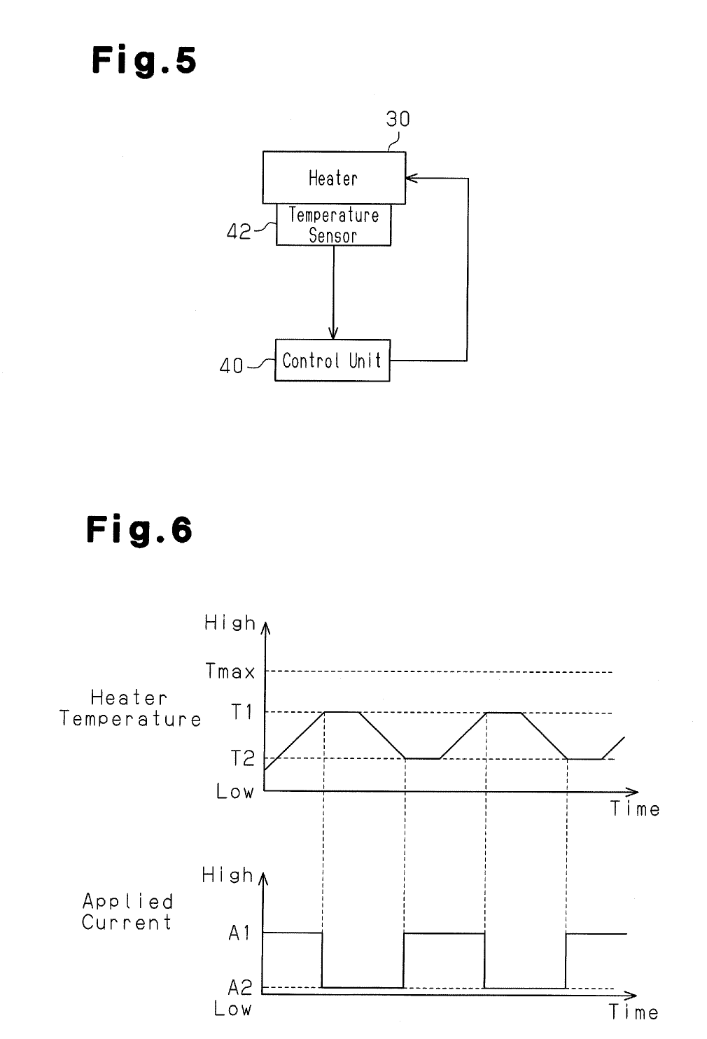

As shown in FIG. 5, the PTC heater 30 is electrically connected to a control unit 40, which controls the current applied to the PTC heater 30. As shown in FIG. 3, a power supply wire 35, which is for supplying power, is connected to the PTC heater 30. The power supply wire 35 is fastened by a fastening member 36 to the arm 22 so that its position in relation with the PTC heater 30 does not change. Further, the power supply wire 35 is connected by a connector 37 to a power supply wire 38, which differs from the power supply wire 35. The power supply wire 38 is connected, for example, to the control unit 40. The control unit 40 controls the current applied to the PTC heater 30 and adjusts the temperature.

The second case member 32 includes an inner surface at the outer side in the lateral direction. A rubber pad 41, which has a high thermal conductance and elasticity and is formed from a silicone, is arranged on the inner surface at a position corresponding to the PTC heater 30. Further, the second case member 32 includes three through holes 32a corresponding to threaded holes formed in the three projections 31d of the first case member 31. Screws 32b are inserted into the through holes 32a and fastened to the threaded holes in the projections 31d of the first case member 31 to couple the first case member 31 to the second case member 32. As shown in FIG. 4, this holds the PTC heater 30 between the abutment portion 31c of the first case member 31 and the rubber pad 41 arranged in the second case member 32. In this structure, the rubber pad 41 is elastically deformed in accordance with the clamping pressure applied by the second case member 32 and the PTC heater 30. In other words, the PTC heater 30 is in contact under pressure with the second case member 32, and heat can be efficiently transferred to the second case member 32.

As shown in FIG. 2, the second case member 32 includes an abutment portion 32d, which can abut the user's body through the cover 13b. The abutment portion 32d has a curved shape. Further, the abutment portion 32d, which is extended outward in the lateral direction by about the same amount as the thickness (length in the lateral direction) of the first case member 31, concentrates the heat of the PTC heater 30 in the second case member 32 and minimizes the diffusion of heat to outside the abutment portion 32d. It is preferred that the first case member 31 and the second case member 32 be shaped in conformance with the PTC heater 30 at parts other than the abutment portion 32d.

The second case member 32 includes an outer surface at the inner side in the lateral direction. As shown in FIG. 3, a temperature sensor 42 is fixed by a screw 32e to the outer surface of the second case member 32. The temperature sensor 42 is electrically connected to the control unit 40. The heat of the PTC heater 30 is transferred to the second case member 32, which is the shell of the heater unit 23, and the temperature sensor 42 monitors the temperature of the heat.

As shown in FIG. 4, an extension 32f, which serves as a first extension projected inward in the lateral direction, is formed on the outer surface of the second case member 32. A generally tetragonal engagement protrusion 32g is formed on a distal end of the extension 32f in the extending direction. The connection member 25, which serves as the second heat transfer unit, is fitted to the extension 32f of the second case member 32. The connection member 25 is generally cylindrical. In a state in which the connection member 25 is fitted to the extension 32f, a screw 46 is fastened to a threaded hole 32h formed in the distal end of the extension 32f to prevent separation of the connection member 25.

The connection member 25 includes a cylindrical portion 25a, which serves as a second extension having a generally constant outer diameter, and an enlarged diameter portion 25b, which has a larger diameter than the cylindrical portion 25a. An inner surface in one end of the cylindrical portion 25a defines an engagement bore 25c, which is generally tetragonal and engages with the engagement protrusion 32g of the extension 32f of the second case member 32. Engagement of the engagement protrusion 32g and the engagement bore 25c in a rotation direction prevents rotation of the connection member 25.

The rubbing roller 24, which is rotatably supported by two bearings 24a and 24b, is arranged on an outer circumferential surface of the cylindrical portion 25a of the connection member 25. The rubbing roller 24 is formed by a single elastic member. In a state in which the rubbing roller 24 is coupled, the enlarged diameter portion 25b, which has a larger diameter than the cylindrical portion 25a, projects inward in the lateral direction from the rubbing roller 24. Accordingly, the enlarged diameter portion 25b prevents separation of the rubbing roller 24 in the lateral direction (axial direction). Further, the rubbing roller 24 is formed by a single member. Thus, in comparison to a separable type rubbing roller formed by a plurality of members like in the prior art, the rigidity of the rubbing roller can be increased. Further, the rubbing roller 24 is formed to have a radius that is slightly greater (approximately 3 mm) than the distance from the axis of the extension 32f of the second case member 32 to the abutment portion 32d of the case member 32. Thus, when the rubbing roller 24 abuts the user's body through the cover 13b and is deformed by the contact pressure, the abutment portion 32d of the second case member 32, which is formed by a rigid body, slightly contacts the user to transfer only heat in a preferred manner. The bearings 24a and 24b are formed by a thermally insulative material. Thus, the transfer of heat to the rubbing roller 24, which is formed by the elastic member, is suppressed.

The temperature control of the heater unit 23 and the massaging motion of the rubbing rollers 24, which are performed in parallel, will now be described with reference to FIGS. 5 to 8.

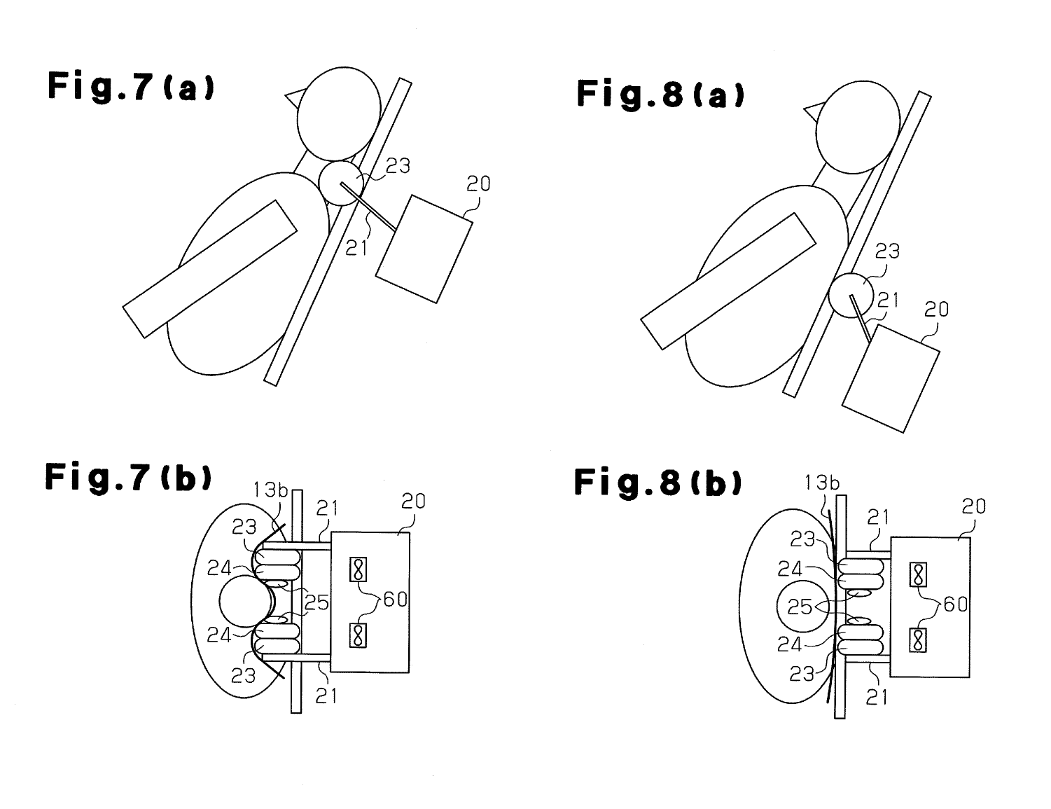

When a power switch (not shown) of the massage machine 10 is turned on, and, for example, a massage course including warm massage is selected with an operation panel, the control unit 40 drives the motor of the massage mechanism 20 and applies predetermined current A1 to the PTC heater 30 (refer to FIG. 6). The maximum output temperature of the PTC heater is Tₘₐₓ. The control unit 40 uses the temperature sensor 42 to monitor the temperature of the second case member 32, to which the heat of the PTC heater 30 is transferred. When the temperature exceeds an upper limit temperature T1, the control unit 40 applies a predetermined current A2, which has a smaller current value than the current A1, to the PTC heater 30. The control unit 40 controls the temperature of the heater unit 23, which is formed by the PTC heater 30 and the first and second case members 31 and 32, to be within the range of the upper limit temperature T1 and the lower limit temperature T2 (refer to FIGS. 6 and 7). In parallel, when performing a massage with the rubbing rollers 24, for example, mainly on the neck, as shown in FIGS. 7(a) and 7(b), the control unit 40 controls the motor of the massage mechanism 20 and moves the massage mechanism 20 to where the user's neck is located. Then, the control unit 40 moves the arm 22 with a motor in the lateral direction to produce a squeezing motion with the two rubbing rollers 24 and massage the user's neck. Here, the connection member 25, which serves as a second heat transfer unit projecting inward in the lateral direction from the rubbing roller 24, abuts the user's neck through the cover 13b and conducts heat from the PTC heater 30 to the user's neck.

When performing a massage with the rubbing rollers 24 mainly on the back in parallel with the temperature control of the heater unit 23, as shown in FIGS. 8(a) and 8(b), the control unit 40 controls the motor of the massage mechanism 20 and moves the massage mechanism 20 to where the user's back is located. The control unit 40 moves the arm 22 with motors in up to down, left to right (lateral), and front to rear directions, to produce a pressing motion or the like with the two rubbing rollers 24 and massage the user's back. Here, the rubbing roller 24 elastically deforms so that the heater unit 23 (the abutment portion 32d of the second case member 32 shown in FIGS. 2 and 3), which serves as the first heat transfer unit, abuts the user's back through the cover 13b and transfers heat from the PTC heater 30 to the user's back.

As described above, the heater unit 23, which serves as the first heat transfer unit, and the connection member 25, which serves as the second heat transfer unit, allows for the transfer of heat to the user's body. In comparison with the massage machine of the prior art, this enlarges the area over which heat is applied to the user, and heat from the PTC heater 30, which serves as a heat source, can be transferred in a preferred manner. Further, the connection member 25 projects inward in the lateral direction from the rubbing roller 24. Thus, when the rubbing rollers 24 are arranged at opposite sides of the user's neck or the like, the connection member 25 contacts the user through the cover 13b. This transfers heat from the PTC heater 30 in a further preferred manner. Further, the power supply wire 35 is fixed to the arm 22. Thus, when moving the massage mechanism 20 and the massaging elements 21 (arms 22) with motors, entanglement of the power supply wire 35 with the massage mechanism 20 and the massaging elements 21 is suppressed.

The massage machine 10 of the present embodiment has the advantages described below.

(1) The massaging element 21 includes the heater unit 23, which accommodates a heat source and which can transfer heat from the heat source to the user, and the connection member 25, which is connected to the heater unit 23 and which can transfer heat from the heater unit 23 to the user. Thus, in addition to the heater unit 23 that accommodates the heat source, the connection member 25 can also apply heat to the user. Accordingly, the region that applies heat to the user can be further enlarged.

(2) The massaging element 21 includes the rubbing roller 24 that presses the user's body. The rubbing roller 24 is held between the heater unit 23 and the connection member 25. In other words, the heater unit 23 and the connection member 25 not only function to transfer heat but also function as two support members that support the rubbing roller 24. In this structure, the two different support members supporting the rubbing roller 24 can apply heat to the user at different locations. Thus, the heat from the PTC heater 30 can be transferred in a further preferred manner.

(3) The connection member 25 is arranged to project inward in the lateral direction of the backrest 13 from the rubbing roller 24. Thus, for example, when performing a massage with the two rubbing rollers 24 at opposite sides of the neck or the like, heat can be transferred to the user from the connection member 25 at the inner sides of the rubbing rollers 24.

(4) The rubbing roller 24 is rotatably supported by the cylindrical portion 25a, which extends from the connection member 25. In this structure, when performing a massage with the rubbing roller 24, friction can be reduced between the rubbing roller 24 and the cover 13b, which is arranged, for example, between the rubbing roller 24 and the user's body.

(5) The connection member 25 includes the engagement recess 25c, which engages the engagement protrusion 32g of the second case member 32 in the rotation direction of the rubbing roller 24, and is prevented from rotating relative to the second case member 32 (i.e., heater unit 23). This prevents the connection member 25 from rotating when the rubbing roller 24 rotates.

(6) The second case member 32, or the case unit 23, includes the extension 32f, which extends inward in the lateral direction toward the rubbing roller 24. The connection member 25 includes the cylindrical portion 25a, which extends outward in the lateral direction toward the rubbing rolling 24. The cylindrical portion 25a of the connection member 25 is fitted to the extension 32f of the second case member 32. In this structure, the area of contact can be increased between the case unit 23 and the connection member 25. This efficiently conducts heat from the case unit 23 to the connection member 25.

(7) The rubbing roller 24 is formed by a single elastic member. Thus, in comparison with a separable type rubbing roller that uses two semispherical elastic members like in the prior art, the rigidity can be increased.

(8) The cylindrical portion 25a of the connection member 25 rotatably supports the rubbing roller 24 with the bearings 24a and 24b, which are formed by a thermally insulative material. In this structure, the transfer of heat to the rubbing roller 24, which is formed by an elastic material such as an elastomer, is suppressed, and deterioration caused by heat can be suppressed.

The above embodiment of the present invention can be varied as described below.

In the above embodiment, the rubbing roller 24 is held between the heater unit 23, which serves as a first heat transfer unit, and the connection member 25, which serves as the second transfer unit. Instead, the rubbing roller 24 may be supported by only the heater unit 23. For example, the extension 32f, which serves as a first extension extending from the second case member 32 of the heater unit 23, may rotatably support the rubbing roller 24. Alternatively, the rubbing roller 24 may be supported by only the connection member 25. For example, the cylindrical portion 25a, which serves as a second extension extending from the connection member 25, may rotatably support the rubbing roller 24. In other words, the rubbing roller 24 can be supported by just one of the heater unit 23 and the connection member 25.

In the above embodiment, the rubbing roller 24 is formed by a single member but may be formed by two or more members.

The rubber pad 41 may be eliminated, and the PTC heater 30 may be directly held between the first case member 31 and the second case member 32.

Although not particularly mentioned in the above embodiment, as shown in FIGS. 7(a) and 7(b) and 8(a) and 8(b), fans 60 may be used to send air currents to the heater units 23. In this case, for example, when the upper limit temperature T1 is reached, the fans 60 send air currents to the heater units 23 to lower the temperature of the heater unit 23.

In the above embodiment, aluminum is used as the material of the first case member 31 and the second case member 32. However, the case members 31 and 32 may be formed from other materials. By forming the second case member 32, which is arranged inward in the lateral direction from the first case member 31, from a material having a higher thermal conductivity than the material of the first case member 31, the heat of the heater 30 can be efficiently transferred to the second case member 32.

In the above embodiment, the connection member 25, which serves as the second heat transfer unit, projects inward in the lateral direction of the backrest 13 from the rubbing roller 24. However, the present invention is not limited in such a manner.

In the above embodiment, the extension 32f, which extends from the second case member 32, is fitted into the cylindrical portion 25a of the connection member 25. However, the present invention is not limited in such a manner. Other structures may be employed. For example, the cylindrical portion 25a may be fitted into the extension 32f.

Although not particularly mentioned in the above embodiment, the extension 32f and the cylindrical portion 25a have a high dimensional accuracy and are designed to increase adhesion and thermal conductivity from the heater unit 23 to the connection member 25. Further, a fixed gap (air layer) may be arranged between the extension 32f and the cylindrical portion 25a, and the gap may be filled with a heat conductive member such as heat conductive grease.

In the above embodiment, the PTC heater 30 is used as the heat source of the heater unit 23. However, other heat sources may be used.

In the above embodiment, the rubbing roller 24 is rotatable about the cylindrical portion 25a due to the bearings 24a and 24b but may be supported so that rotation is prohibited.

Although not particularly mentioned in the above embodiment, a lubricant, such as grease, may be applied to the contact surface of the rubbing roller 24 that contacts the cover 13b. This suppresses friction between the rubbing roller 24 and the cover, and the durability of the rubbing roller 24 and the cover 13b can be improved.

Although not particularly mentioned in the above embodiment, a massaging means such as an airbag may be arranged in the upper surface of the ottoman 14 or the seat 12.

In the above embodiment, the backrest 13 is reclinable. However, the backrest 13 may be non-reclinable.

In the above embodiment, the ottoman 14 is arranged at the front part of the seat 12. However, the ottoman 14 may be eliminated.

1. A massage machine comprising:
a seat;
a backrest;
a massage mechanism arranged in the backrest; and
a massaging element arranged in the massage mechanism, wherein the massaging element includes:
an arm connected to the massage mechanism;
a first heat transfer unit arranged in the arm, wherein the first heat transfer unit accommodates a heat source and is capable of transferring heat from the heat source to a user;
a second heat transfer unit connected to the first heat transfer unit, wherein the second heat transfer unit is capable of transferring heat from the first heat transfer unit to the user; and
a rubbing roller supported by at least one of the first and second heat transfer units.

2. The massage machine according to claim 1, wherein the rubbing roller is held between the first heat transfer unit and the second heat transfer unit.

3. The massage machine according to claim 1, wherein:
the massaging element is one of two massaging elements arranged in a lateral direction of the backrest; and
the second heat transfer unit projects inward in the lateral direction of the backrest from the rubbing roller.

4. The massage machine according to claim 1, wherein the rubbing roller is rotatable relative to an extension that extends from the first heat transfer unit or the second heat transfer unit.

5. The massage machine according to claim 4, wherein the second heat transfer unit is engaged with the first heat transfer unit in a rotation direction of the rubbing roller and thereby prevented from rotating.

6. The massage machine according to claim 4, wherein the rubbing roller is supported by a thermally insulative bearing to be rotatable relative to the extension.

7. The massage machine according to claim 1, wherein the rubbing roller is formed by a single member.

8. The massage machine according to claim 1, wherein:
the first heat transfer unit includes a first extension;
the second heat transfer unit includes a second extension; and
the first extension of the first heat transfer unit is fitted to the second extension of the second heat transfer unit.

9. The massage machine according to claim 1, wherein:
the first heat transfer unit includes:
first and second case members, which are thermally conductive; and
a rubber pad, which is thermally conductive and elastic;
the heat source is held between the first and second case members in a state in which the rubber pad is arranged between the heat source and the second case member; and
the second heat transfer unit is connected to the second case member.

10. The massage machine according to claim 2, wherein the rubbing roller is rotatable relative to an extension that extends from the first heat transfer unit or the second heat transfer unit.

11. The massage machine according to claim 10, wherein the second heat transfer unit is engaged with the first heat transfer unit in a rotation direction of the rubbing roller and thereby prevented from rotating.

12. The massage machine according to claim 10, wherein the rubbing roller is supported by a thermally insulative bearing to be rotatable relative to the extension.

13. The massage machine according to claim 3, wherein the rubbing roller is rotatable relative to an extension that extends from the first heat transfer unit or the second heat transfer unit.

14. The massage machine according to claim 13, wherein the second heat transfer unit is engaged with the first heat transfer unit in a rotation direction of the rubbing roller and thereby prevented from rotating.

15. The massage machine according to claim 13, wherein the rubbing roller is supported by a thermally insulative bearing to be rotatable relative to the extension.
